(19) United States
(12) Patent Application Publication
(10) Pub. No.: US 2010/0265226 A1
(43) Pub. Date: Oct. 21, 2010

(54) DISPLAY DEVICE

(75) Inventor: Kozo YASUDA, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/759,165

(22) Filed: Apr. 13, 2010

(30) Foreign Application Priority Data
Apr. 17, 2009 (JP) 2009-100433

(51) Int. Cl. G09G 5/00

(52) U.S. Cl. 345/206

(57) ABSTRACT

A control electrode of j (1≦j≦N−1)th transistor is connected to gate lines of (j+1)th group. A scanning line drive circuit outputs a first selection scanning voltage selecting scanning lines within each of groups for every 1 horizontal scanning period to gate lines of k1 gate line of a first group, outputs a second selection scanning voltage for selecting scanning lines in one group out of groups at a second stage where a group including k1 scanning lines is set as 1 unit for every k1 horizontal scanning period to k2 gate lines of a second group, and outputs (m+1)th selection scanning voltage for selecting the scanning lines in one group out of the groups at (m+1)th stage where a group including km scanning lines is set as 1 unit for every (km× . . . ×k1) horizontal scanning period to gate lines of (m+1)th group having k(m+1) (2≦m≦N−1) gate lines.

### CROSS-REFERENCE TO RELATED APPLICATION

The present application claims priority from Japanese Applications JP2009-100433 filed on Apr. 17, 2009, the content to which is hereby incorporated by reference into this application.

### BACKGROUND OF THE INVENTION

1. Field of the Invention

The present invention relates to a display device such as a liquid crystal display device or an EL display device, and more particularly to a technique for reducing wiring from a video line drive circuit or a scanning line drive circuit to a display panel.

2. Description of the Related Art

Currently, a liquid crystal display panel, which is used in a liquid crystal television receiver set, a mobile phone or the like, is a TFT-method liquid crystal display device. FIG. 1 shows an equivalent circuit of a conventional TFT-method active-matrix-type liquid crystal display panel.

As shown in FIG. 1, a conventional liquid crystal display panel includes a plurality of scanning lines (also referred to as gate lines) (GL) and a plurality of video lines (also referred to as source lines or drain lines) (DL) on a liquid-crystal-side surface of one of a pair of substrates that are arranged to face each other via liquid crystal sandwiched therebetween.

Regions surrounded by the scanning lines and the video lines form sub pixel regions, and each sub pixel region is provided with a thin film transistor (TFT) which constitutes an active element. Here, in the thin film transistor (TFT), a gate is connected to the scanning line, a drain (or a source) is connected to the video line, and the source (or the drain) is connected to a pixel electrode (PX).

Liquid crystal is interposed between the pixel electrode (PX) and a counter electrode (CT) and hence, liquid crystal capacitance (Clc) is formed between the pixel electrode (PX) and the counter electrode (CT). Although holding capacitance (Cadd) is formed between the pixel electrode (PX) and the counter electrode (also referred to as common electrode) (CT) in an actual circuit, in FIG. 1, the illustration of the holding capacitance (Cadd) is omitted. The respective scanning lines (GL) are connected to a vertical scanning circuit (also referred to as gate driver) (XDV), and the vertical scanning circuit (XDV) supplies a selection signal to the respective scanning lines (GL) sequentially.

The respective video lines (DL) are connected to a horizontal scanning circuit (also referred to as source driver or drain driver) (YDV), and the horizontal scanning circuit (YDV) outputs video voltages (so-called grayscale voltages) of R, G, B to the respective video lines (DL) within 1 horizontal scanning period.

As the thin film transistor (TFT), a thin film transistor which forms a semiconductor layer using an amorphous silicon layer (hereinafter referred to as a-Si thin film transistor), and a thin film transistor which forms a semiconductor layer using a poly-silicon layer (hereinafter referred to as poly-Si thin film transistor) are known. Further, as the thin film transistor (TFT), recently, there has been also known a thin film transistor which forms a semiconductor layer using a micro-crystalline-silicon layer (hereinafter referred to as micro-crystalline-silicon thin film transistor). This micro-crystalline thin film transistor has an approximately intermediate function between a function of the a-Si thin film transistor and a function of the poly-Si thin film transistor.

In general, in a liquid crystal display panel for a liquid crystal television receiver set, the a-Si thin film transistor is used as an active element, while in a liquid crystal display panel for a mobile phone, the poly-Si thin film transistor is used as an active element.

The operation speed of the poly-Si thin film transistor is faster than that of the a-Si thin film transistor by approximately one digit, and, thus, in a liquid crystal display panel using the poly-Si thin film transistor as an active element, the vertical scanning circuit (XDV) is constituted of the poly-Si thin film transistor, and the vertical scanning circuit (XDV) is formed on a liquid-crystal-side surface of one of a pair of substrates which constitute a liquid crystal display panel.

The operation speed of the a-Si thin film transistor or the micro-crystalline-silicon thin film transistor is slower than that of the poly-Si thin film transistor, and, hence, a vertical scanning circuit (XDV) which is constituted of the a-Si thin film transistor cannot be formed in the inside of the liquid crystal display panel. Accordingly, in a liquid crystal display panel which uses the a-Si thin film transistor or micro-crystalline-silicon thin film transistor as an active element, a semiconductor chip which mounts a vertical scanning circuit (XDV) thereon is mounted on one of a pair of substrates which constitute a liquid crystal display panel, for example.

### SUMMARY OF THE INVENTION

In general, as a method of mounting semiconductor chips which constitute a vertical scanning circuit (XDV) and a horizontal scanning circuit (YDV), there have been known following two methods. In one method, as shown in FIG. 1, the semiconductor chip which constitutes the vertical scanning circuit (XDV) and the semiconductor chip which constitutes the horizontal scanning circuit (YDV) are separately mounted on one of a pair of substrates which are arranged to face each other with liquid crystal sandwiched therebetween. In another method, as shown in FIG. 2, a semiconductor chip constituting a scanning circuit (RDV) formed by integrating a vertical scanning circuit (XDV) and a horizontal scanning circuit (YDV) is mounted on one of a pair of substrates which are arranged to face each other with liquid crystal sandwiched therebetween.

In both methods, a selection scanning voltage is applied to respective scanning lines (GL) from the vertical scanning circuit (XDV) (or scanning circuit (RDV)) and hence, the number of gate lines which connect the vertical scanning circuit (XDV) (or scanning circuit (RDV)) and the respective scanning lines (GL) which is equal to the scanning lines (GL) in the number thereof become necessary.

However, in a miniaturized panel such as a liquid crystal display panel of a mobile phone or the like, when the number of pixels is increased so as to satisfy a demand for higher definition, there may be a case where wiring in the liquid crystal display panel becomes impossible.

To overcome the above-mentioned problems, the use of an n-bit address decoder circuit in a vertical scanning circuit (XDV) is disclosed in JP-A-2001-305510 (patent document 1). However, in the n-bit address decoder circuit disclosed in the patent document 1, there is a problem that the constitution of the circuit is complicated and that the number of transistors used therein is large.

One aspect of the present invention has been made to overcome the above-mentioned problems of the related art, and it is an object of one aspect of the present invention to provide a technique for reducing a number of lines between a scanning circuit and a plurality of scanning lines using a circuit constitution that is simpler than a conventional circuit constitution.

The above-mentioned and other objects and novel technical features of the present invention will become apparent from the description of this specification and attached drawings.

The followings are brief explanations of the summary of typical inventions among the inventions described in this specification.

(1) According to one aspect of the present invention, A display device includes a plurality of pixels, a plurality of scanning lines configured to input a scanning voltage to the plurality of pixels, and a scanning line drive circuit configured to supply the scanning voltage to the plurality of scanning lines. The scanning lines are divided into kN× . . . ×k2 groups assuming N as an integer of 2 or more. The number of the scanning lines in each of the groups is k1 at maximum. Where n as an integer not less than 1 and not more than N, j as an integer not less than 1 and not more than N−1, and m as an integer not less than 2 and not more than N−1 or less, the display device further includes a first gate line group to an Nth gate line group of gate lines. Each of the first gate line group to the Nth gate line group of the gate lines include kn (1≦n≦N) gate lines respectively. The display device further includes series circuits having (N−1) transistors ranging from a first transistor to a (N−1)th transistor. Each of the (N−1) transistors is provided for each of the scanning lines. One end of each of the scanning lines is connected to a second electrode of the (N−1)th transistor. A first electrode of the first transistor is connected to any one of the gate lines of the first gate line group. A control electrode of the j (1≦j≦N−1)th transistor is connected to any one of the gate lines of the (j+1) th gate line group. The scanning line drive circuit outputs a first selection scanning voltage for selecting the scanning lines within each of the groups for every 1 horizontal scanning period to the gate lines of the first gate line group including k1 gate lines. The scanning line drive circuit outputs a second selection scanning voltage for selecting the scanning lines in one second group out of second groups where the group including k1 scanning lines is set as 1 unit for every k1 horizontal scanning periods to the gate lines of the second gate line group including k2 gate lines. The scanning line drive circuit outputs the (m+1)th selection scanning voltage for selecting the scanning lines in one (m+1)th group out of (m+1)th groups where a mth group including km scanning lines is set as 1 unit for every (km× . . . ×k1) horizontal scanning periods to the gate lines of the (m+1)th gate line group having k(m+1) (2≦m≦N−1) gate lines.

(2) In the display device according to (1), assuming p as an integer not less than 2 and not more than N, a difference between k(p−1) and kp(2≦p≦N) is set to N or less.

(3) In the display device according to (1), the selection scanning voltage is outputted to all the gate lines of the second gate line group to the Nth gate line group from the scanning line drive circuit. A non-selection scanning voltage is outputted to all the gate lines of the first gate line group within a period T1 at the beginning of said each horizontal scanning period.

(4) In the display device according to (3), the scanning line drive circuit, after a lapse of the period T1, outputs a non-selection scanning voltage to the gate lines other than the gate lines to which the second to the Nth selection scanning voltages are outputted out of the gate lines of the second gate line group to the Nth gate line group. The scanning line drive circuit, after a lapse of a period T2 which continuously follows the period T1, outputs the first selection scanning voltage to the gate lines selected out of the gate lines of the first gate line group.

(5) In the display device having any one of (1) to (4), a video line drive circuit and the scanning line drive circuit are formed of the same semiconductor chip.

(6) In the display device having any one of the constitutions (1) to (5), each of the plurality of pixeles includes a thin film transistor which is an active element. A semiconductor layer of the thin film transistor is formed of an amorphous silicon layer.

(7) In the display device according to (6), the semiconductor layer of the (N−1) transistors ranging from the first transistor to the (N−1) th transistor is formed of an amorphous silicon layer.

To explain advantageous effects obtained by the typical inventions among inventions described in this specification, they are as follows.

According to the display device of the present invention, it is possible to reduce the number of lines between a scanning circuit and a plurality of scanning lines with the circuit constitution simpler than the circuit constitution of a related art.

### BRIEF DESCRIPTION OF THE DRAWINGS

FIG. 1 is a diagram showing an equivalent circuit of a conventional TFT-method active-matrix-type liquid crystal display panel.

FIG. 2 is a diagram showing an equivalent circuit of another conventional TFT-method active-matrix-type liquid crystal display panel.

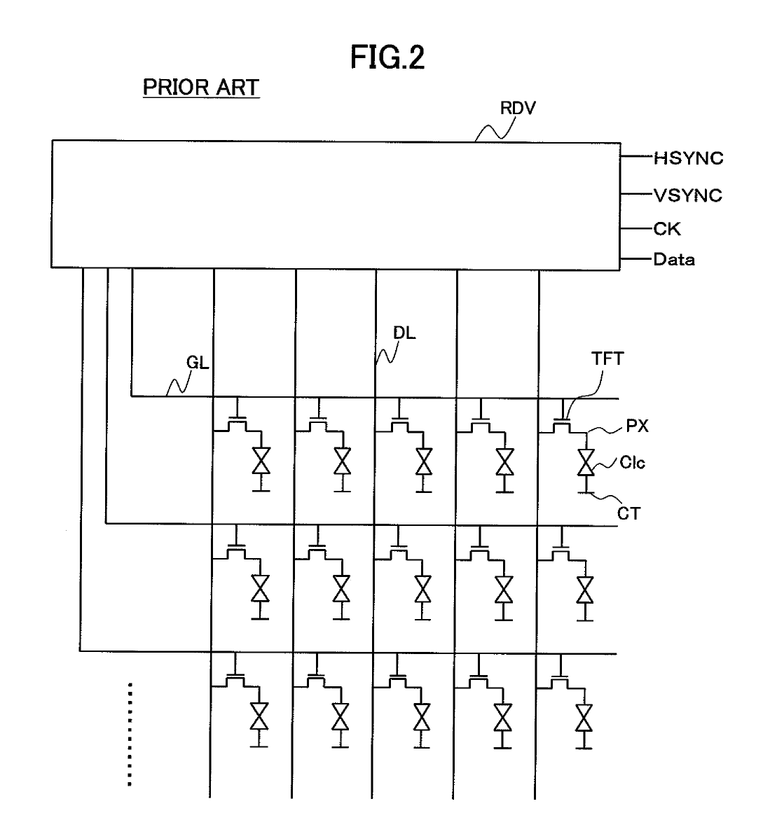

FIG. 3 is a diagram showing an equivalent circuit of a TFT-method active-matrix-type liquid crystal display panel according to Embodiment 1 of the present invention.

FIG. 4 is a timing chart for explaining a driving method of the liquid crystal display panel according to Embodiment 1 of the present invention.

FIG. 5 is a diagram showing an equivalent circuit of a TFT-method active-matrix-type liquid crystal display panel according to Embodiment 2 of the present invention.

FIG. 6A to FIG. 6C are timing charts for explaining a driving method of the liquid crystal display panel according to Embodiment 2 of the present invention.

FIG. 7 is a diagram showing an equivalent circuit of another conventional TFT-method active-matrix-type liquid crystal display panel.

FIG. 8 is a timing chart for explaining a driving method of a modification of the liquid crystal display panel according to Embodiment 1 of the present invention.

### DETAILED DESCRIPTION OF THE INVENTION

Hereinafter, embodiments of the present invention are explained in detail in conjunction with drawings.

Here, in all drawings for explaining the embodiments, parts having identical functions are given the same symbols and their repeated explanation is omitted.

### Embodiment 1

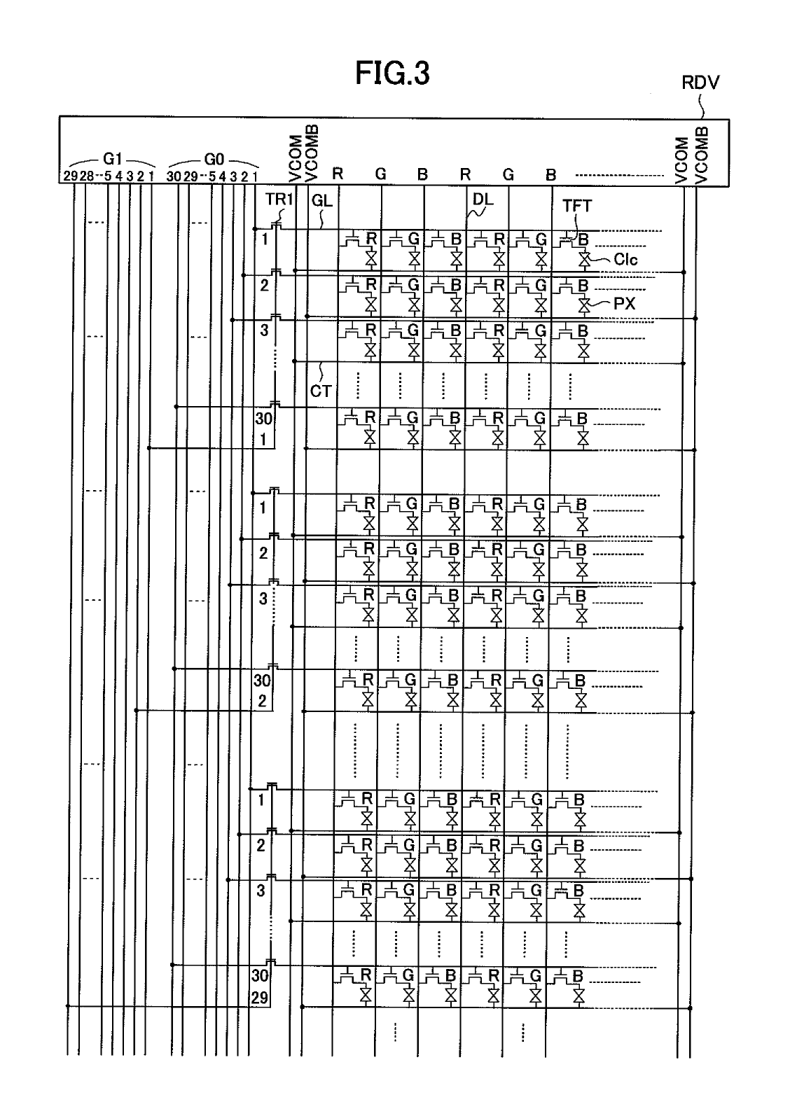

FIG. 3 is a diagram showing an equivalent circuit of a TFT-method active-matrix-type liquid crystal display panel according to Embodiment 1 of the present invention.

As shown in FIG. 3, a liquid crystal display panel of this embodiment includes a plurality of scanning lines (also referred to as gate lines) (GL) and a plurality of video lines (also referred to as source lines or drain lines) (DL) on a liquid-crystal-side surface of one of a pair of substrates which is arranged to face each other with liquid crystal sandwiched therebetween.

Regions surrounded by the scanning lines and the video lines form sub pixel regions, and each sub pixel region is provided with a thin film transistor (TFT) which constitutes an active element. Here, in the thin film transistor (TFT), the gate is connected to the scanning line, the drain (or a source) is connected to the video line, and the source (or the drain) is connected to a pixel electrode (PX).

Liquid crystal is interposed between the pixel electrode (PX) and a counter electrode (CT) and hence, liquid crystal capacitance (Clc) is formed between the pixel electrode (PX) and a counter electrode (CT). Although holding capacitance (Cadd) is formed between the pixel electrode (PX) and the counter electrode (also referred to as common electrode) (CT) in an actual circuit, in FIG. 3, the illustration of the holding capacitance (Cadd) is omitted.

The respective video lines (DL) are connected to a scanning circuit (RDV) which incorporates a horizontal scanning circuit and a vertical scanning circuit therein. The scanning circuit (RDV) outputs video voltages (so-called gray-scale voltages) of R, G, B to the video lines (DL) within 1 horizontal scanning period.

Here, in FIG. 3, symbol VSYNC indicates a vertical synchronizing signal, symbol HSYNC indicates a horizontal synchronizing signal, symbol CK indicates a dot clock, and symbol Data indicates video data.

The liquid crystal display panel of this embodiment is constituted as follows. A first substrate (also referred to as a TFT substrate or an active matrix substrate) (not shown in the drawing) on which pixel electrodes, thin film transistors and the like are mounted and a second substrate (also referred to as a counter substrate) (not shown in the drawing) on which color filters and the like are formed overlap with each other with a predetermined gap therebetween, and the both substrates are adhered to each other using a frame-shaped sealing material which is formed between both of the substrates and on the vicinity of peripheral portions of the both substrates. Liquid crystal is filled and sealed in a space defined by the sealing material and the both substrates through a liquid-crystal filling port which is formed in a portion of the sealing material. Further, a polarizer is adhered to outer sides of the both substrates respectively.

In this manner, the liquid crystal display panel of this embodiment is configured such that liquid crystal is sandwiched between the pair of substrates. Further, when the liquid crystal display panel is of a TN type or a VA type, the counter electrodes are formed on a second substrate (counter substrate) side. When the liquid crystal display panel is of an IPS type, the counter electrodes are formed on a first substrate (TFT substrate) side.

Here, the present invention is irrelevant to the inner structure of the liquid crystal display panel and hence, the detailed explanation of the inner structure of the liquid crystal display panel is omitted. Further, the present invention is applicable to a liquid crystal display panel having any structure.

Hereinafter, the liquid crystal display panel of this embodiment is explained assuming that the number of scanning lines (GL) is 870.

In this embodiment, the scanning lines (GL) are driven with two-stage constitution. Accordingly, in this embodiment, the scanning lines (GL) are divided into k2 (29 in this embodiment) groups. In FIG. 3, the number of the scanning lines (GL) of each group is set to k1 (30 in this embodiment) at maximum, and “k2” is set to 29 and hence, the total number of the scanning lines (GL) becomes 870 (=30×29). Accordingly, the scanning circuit (RDV) includes k1 terminals of the first group (G0) and k2 terminals of the second group (G1) as terminals for the scanning lines (GL).

In this embodiment, one end of each scanning line (GL) is connected to second electrodes (drains or sources) of transistors (TR1). First electrodes (sources or drains) of the transistors (TR1) are connected to any one of the gate lines which are connected to the terminals (G0) of the first group. Further, gates of the transistors (TR1) are connected to any one of the gate lines which are connected to the terminals of the second group (G1).

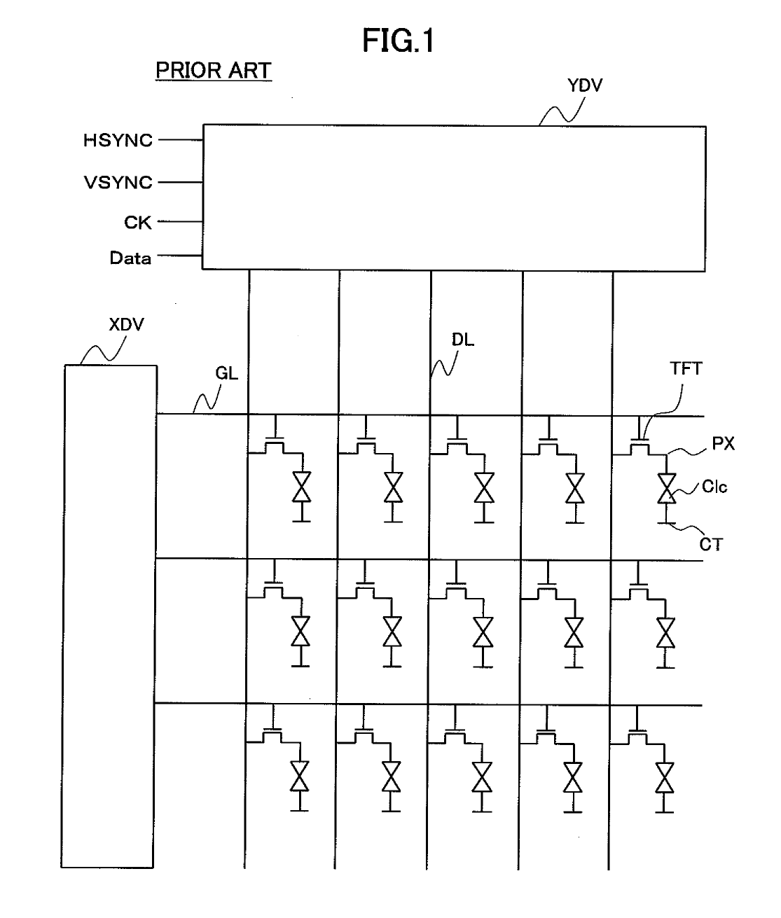

In FIG. 3, the scanning circuit (RDV) may adopt the circuit constitution where the vertical scanning circuit (XDV) and the horizontal scanning circuit (YDV) are provided separately from each other as shown in FIG. 1. Here, the scanning circuit (RDV) (or the vertical scanning circuit (XDV) and the horizontal scanning circuit (YDV)) is constituted of a circuit incorporated in a semiconductor chip, and the semiconductor chip is mounted on one substrate out of the pair of substrates which constitutes the liquid crystal display panel.

Further, in FIG. 3, symbols VCOM and VCOMB indicate output terminals for outputting counter voltages supplied to the counter electrodes (CT). When a counter voltage having positive polarity is outputted to the terminal VCOM, a counter voltage having negative polarity is outputted to the terminal VCOMB, while when a counter voltage having negative polarity is outputted to the terminal VCOM, a counter voltage having positive polarity is outputted to the terminal VCOMB.

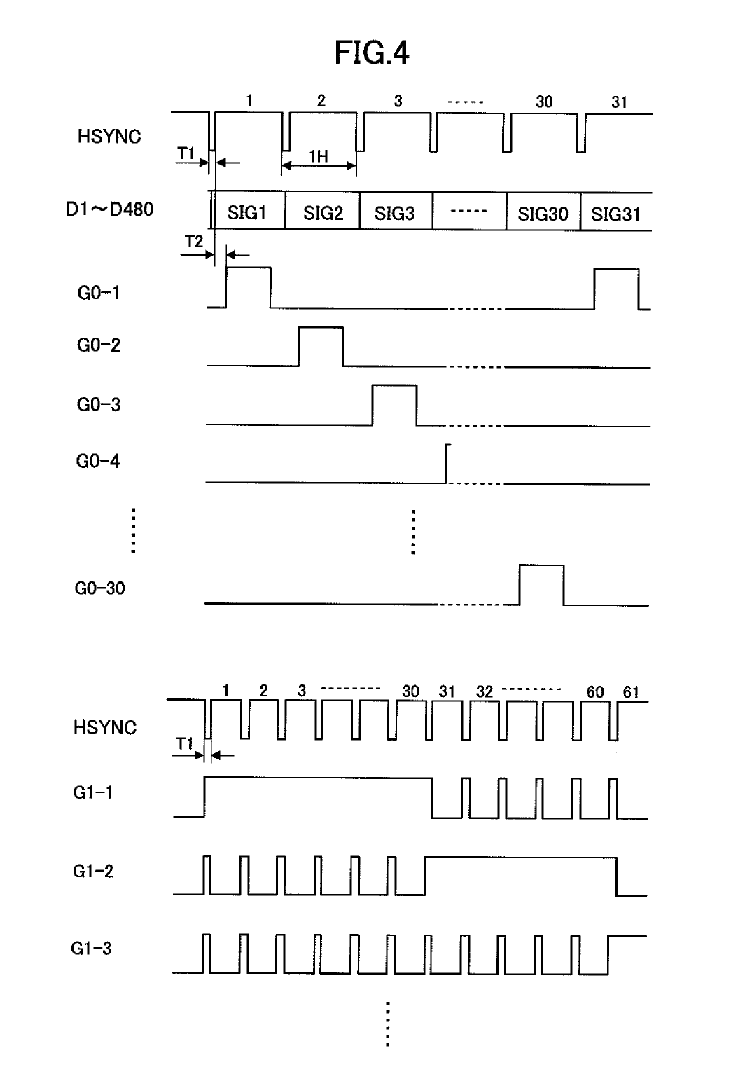

FIG. 4 is a timing chart for explaining a driving method of the liquid crystal display panel of this embodiment.

As shown in FIG. 4, the scanning circuit (RDV) sequentially outputs a selection scanning voltage of High-level (hereinafter, H-level) to terminals G0-1 to G0-30 out of the terminals of the first group (G0) for every 1 horizontal scanning period (HSYNC; hereinafter, referred to as “1H period”) (base 30 number system).

Further, as shown in FIG. 4, the scanning circuit (RDV) sequentially outputs a selection scanning voltage of H-level to terminals G1-1 to G1-29 out of the terminals of the second group (G1) for every 30H period (base 29 number system). That is, each terminal of the terminals of the second group (G1), in a state where one group is formed of 30 scanning lines (GL), sequentially outputs a selection signal of H level to the gates of the transistors (TR1) which are connected to the scanning lines (GL) in each group for every 30H period.

When a selection scanning voltage of H level is outputted to the terminals which are selected out of the terminals of the second group (G1), the transistors (TR1) whose gates are respectively connected to the gate lines connected to the selected terminal are turned on. For example, when a selection scanning voltage of H level is outputted to the terminal G1-1 out of the terminals of the second group (G1), the transistors (TR1) which are connected to the scanning lines of the first group (GL) are turned on so that the scanning lines of the first group (GL) are selected.

Next, when a selection scanning voltage of H level is outputted from the terminal selected from the terminals of the first group (G0), the scanning line (GL) selected within the selected group i.e., the gate line connected to the terminal selected out of the terminals of the first group (G0), is connected to the first electrode of the transistor (TR1), and the selection scanning voltage is supplied to the scanning line (GL) connected to the transistor (TR1) i.e., the gate line which is connected to the terminal selected out of the terminals of the second group (G1).

Thus, the gate of the thin film transistor (active element) (TFT) which is connected to the scanning line (GL) selected in the selected group is turned on, and a video voltage (grayscale voltage) is written from the video line (DL) in the pixel electrode (PX) via the thin film transistor (TFT).

Next, when a selection scanning voltage of H level is outputted from the terminal next selected out of the terminals of the first group (G0), the gate of the thin film transistor (active element) (TFT) which is connected to the scanning line (GL) next selected in the selected group is turned on, and a video voltage is written in the pixel electrode (PX) from the video line (DL) by way of the thin film transistor (TFT).

By sequentially selecting the scanning lines (GL) in this manner, an image is displayed on the liquid crystal display panel.

As described previously, the scanning lines (GL) are sequentially selected, and a video voltage outputted from the scanning circuit (RDV) is written in pixels on the selected scanning line (GL).

However, the scanning lines (GL) other than the selected scanning line (GL) are in a floating state at this time and hence, being influenced by a change of a video voltage supplied to the video line (DL), a voltage of the scanning line (GL) in a floating state rises, and a thin film transistor (TFT) whose gate connected to the scanning line (GL) in a floating state is turned on so that there exists a possibility that a video voltage is written in a pixel other than the selected pixel.

To prevent such writing of the video voltage in other pixels, as shown in FIG. 4, within a predetermined time at the beginning of 1 horizontal period (period T1 shown in FIG. 4), a scanning voltage of H level is outputted to all the terminals of the second group (G1). Simultaneously, a voltage of Low level (hereinafter referred to as L level) is outputted to all the terminals of the first group (G0).

Accordingly, all the scanning lines (GL) are fixed to L level. Thereafter, a video voltage is outputted to the video lines (DL) from the scanning circuit (RDV). Even when a voltage on the video lines (DL) is changed, the scanning lines (GL) are fixed to the L level and hence, a voltage of the scanning lines (GL) does not rise.

Next, as indicated by the waveform of a voltage supplied to the terminal (G1-1) in FIG. 4, the terminal to be selected out of the terminals of the second group (G1) is held at H level, and other terminals are held at L level. Then, after a period T2 which continuously follows the period T1 elapses, that is, after a voltage change on the video line (DL) is settled, a selection scanning voltage of H level is supplied to the terminals (G0) of the first group sequentially so that a video voltage is written in the selected pixels and an image is displayed.

In this embodiment, when the number of the terminals of the first group (G0) and the number of the terminals of the second group (G1) are equal, the number of the gate lines which connect the terminals of the first group (G0) and the terminals of the second group (G1) with the scanning lines (GL) becomes minimum. It is preferable to set the difference between k1 and k2 to 2 or less.

In this embodiment, the number of the gate lines which connect the terminals of the first group (G0) with the scanning lines (GL) and the number of the gate lines which connect the terminals of the second group (G1) with the scanning lines (GL) are 30 and 29 respectively and hence, these numbers are substantially equal. In this case, the total number of gate lines is minimized (total 59=30+29). That is, while 870 gate lines are necessary when connecting scanning circuit (RDV) with all the scanning lines (GL) using the gate lines one by one, the number of the gate lines can be reduced to 59.

In addition, as described later, a relationship between the number of transistors and the number of gate lines is trade-off. In this embodiment, when the performance necessary for the rising and falling of the scanning line (GL) is not obtained unless the size of the transistor is increased as in the case of the liquid crystal display panel using an a-Si thin film transistor or the like as an active element, the number of transistors can be decreased. As a result, although the number of gate lines is increased, the total area can be made small, and this embodiment is effective.

Further, when an a-Si thin film transistor is used as the active element, the transistor (TR1) shown in FIG. 3 is also formed using a-Si. When a micro-crystalline Si thin film transistor is used as the active element, the transistor (TR1) shown in FIG. 3 is also formed using micro-crystalline a-Si.

### Embodiment 2

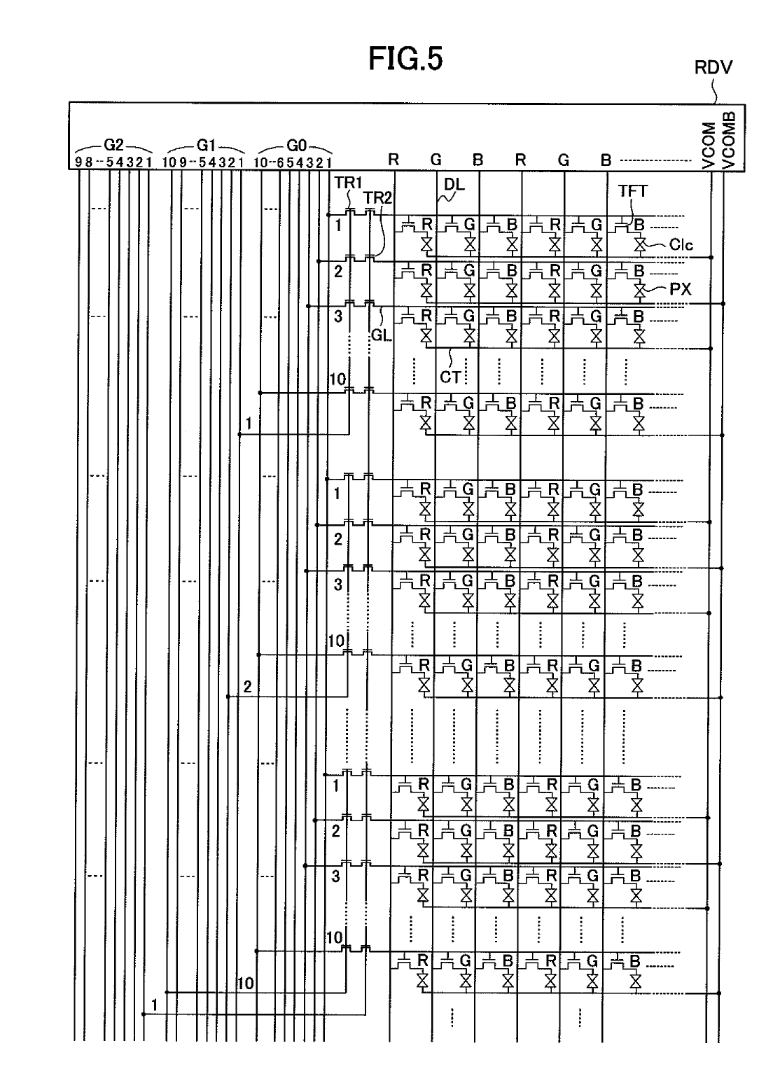

FIG. 5 shows an equivalent circuit of a TFT-method active-matrix-type liquid crystal display panel according to an embodiment 2 of the present invention.

This embodiment is directed to a case where the scanning lines (GL) are driven with three-stage constitution. In this embodiment, the scanning lines are divided into groups of k3×k2. The number of scanning lines (GL) in respective groups is k1 at maximum.

In FIG. 5, k2 is 10 and k3 is 9 and hence, in this embodiment, the scanning lines (GL) are divided into 90 groups. Further, k1 is 10 and hence, the maximum total number of scanning lines (GL) becomes 900 (=10×10×9).

In this embodiment, when the number of terminals of the first group (G0), the number of terminals of the second group (G1) and the number of terminals of the third group (G2) are equal, the number of gate lines which connect the terminals of the first group (G0), the terminals of the second group (G1) and the terminals of the third group (G2) with the scanning lines (GL) becomes minimum. It is preferable to set the difference between k1 and k2 and the difference between k2 and k3 to 3 or less.

In this embodiment, the number of gate lines which connect the terminals of the first group (G0) with the scanning lines (GL) the number of gate lines which connect the terminals of the second group (G1) with the scanning lines (GL), and the number of gate lines which connect the terminals of the third group (G2) with the scanning lines (GL) become 10, 10, 9 respectively and hence, these numbers are substantially equal. Here, the total number of gate lines is minimized (29=10+10+9). That is, while 870 gate lines become necessary when the gate lines are provided between the scanning circuit (RDV) and all the scanning lines (GL) one by one, the number of gate lines can be reduced to 29.

Further, compared to the above-mentioned embodiment, in this embodiment, the number of transistors connected to each scanning line (GL) is increased to two, that is, TR1 and TR2, while the number of lines is substantially halved (59 to 29).

In this embodiment, as shown in FIG. 5, the scanning circuit (RDV) includes, as terminals for the scanning lines (GL), k1 terminals of the first group (G0), k2 terminals of the second group (G1), and k3 terminals of the third group (G2).

In this embodiment, one end of each scanning line (GL) is connected to second electrodes (drains or sources) of second transistors (TR2). First electrodes (sources or drains) of the second transistors (TR2) are connected to the second electrodes of the first transistors (TR1).

First electrodes (sources or drains) of the first transistors (TR1) are connected to any one of the gate lines which are connected to the terminals (G0) of the first group.

Further, the gate of the first transistor (TR1) is connected to any one of the gate lines connected to the terminals (G1) of the second group, and the gate of the second transistor (TR2) is connected to any one of the gate lines connected to the terminals (G2) of the third group.

In FIG. 5, the scanning circuit (RDV) may adopt the circuit constitution separately from the vertical scanning circuit (XDV) and the horizontal scanning circuit (YDV) as shown in FIG. 1. Here, the scanning circuit (RDV) (or the vertical scanning circuit (XDV) and the horizontal scanning circuit (YDV)) are each constituted of a circuit incorporated in a semiconductor chip, and the semiconductor chip is mounted on one substrate out of the pair of substrates which constitutes the liquid crystal display panel.

Further, in FIG. 5, symbols VCOM and VCOMB indicate output terminals for outputting counter voltages supplied to the counter electrodes (CT). When a counter voltage having positive polarity is outputted to the terminal VCOM, a counter voltage having negative polarity is outputted to the terminal VCOMB, while when a counter voltage having negative polarity is outputted to the VCOM terminal, a counter voltage having positive polarity is outputted to the VCOMB terminal.

Further, when an a-Si thin film transistor is used as the active element, the first transistor (TR1) and the second transistor (TR2) shown in FIG. 5 are also formed using a-Si. When a micro-crystalline Si thin film transistor is used as the active element, the first transistor (TR1) and the second transistor (TR2) shown in FIG. 5 are also formed using micro-crystalline Si.

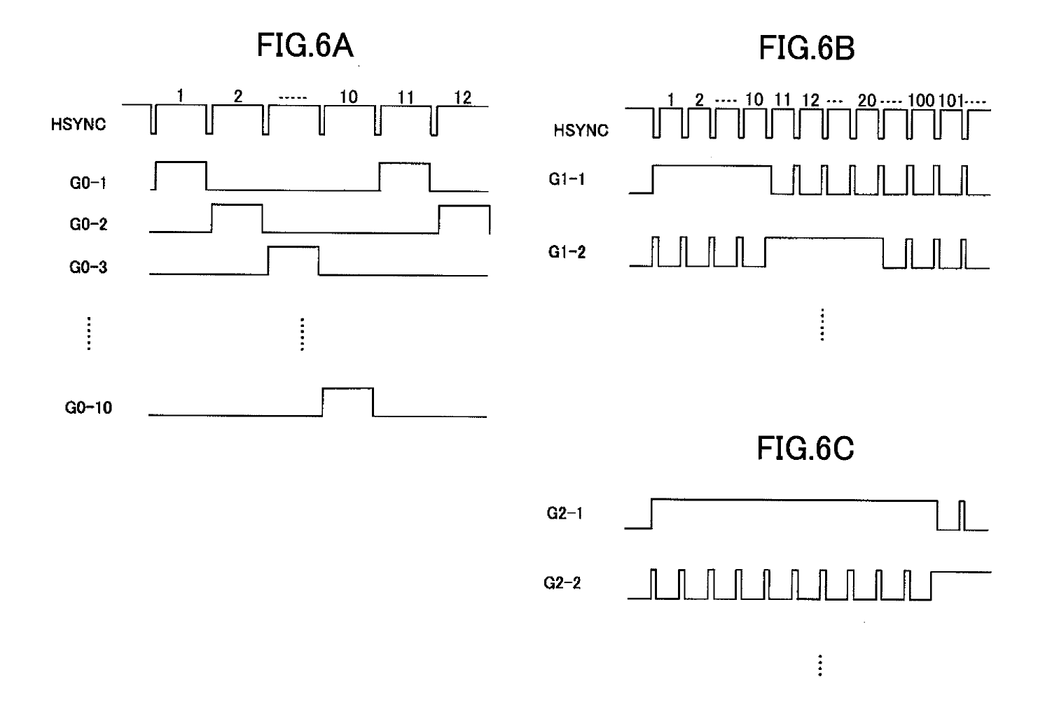

FIG. 6A to FIG. 6C show timing charts for explaining a driving method of the liquid crystal display panel of this embodiment.

As shown in FIG. 6A, the scanning circuit (RDV) sequentially outputs a selection scanning voltage of High-level (hereinafter, H-level) to terminals G0-1 to G0-10 out of the terminals of the first group (G0) for every 1 horizontal scanning period (HSYNC; hereinafter, referred to as “1H period”) (base 10 number system).

Further, as shown in FIG. 6B, the scanning circuit (RDV) sequentially outputs a selection scanning voltage of H-level to terminals G1-1 to G0-10 out of the terminals of the second group (G1) for every 10H period (base 10 number system). That is, each terminal out of the terminals of the second group (G1) sequentially outputs, in a state where one group is formed of 10 scanning lines (GL), a selection scanning signal of H level to the gates of the first transistors (TR1) which are connected to the scanning lines (GL) in each group for every 10H period.

Further, as shown in FIG. 6C, the scanning circuit (RDV) sequentially outputs a selection scanning voltage of H-level to terminals G2-1 to G2-9 out of the terminals of the third group (G2) for every 100H period (=10H×10) (base 9 number system). That is, each terminal out of the terminals of the third group (G2) sequentially outputs, in a state where one group is formed of 100 scanning lines (GL), a selection scanning signal of H level to the gates of the second transistors (TR2) which are connected to the scanning lines (GL) in each group for every 100H period.

Further, when a selection scanning voltage of H level is outputted to the terminals which are selected from the terminals of the second group (G1) and the terminals of the third group (G2), the first transistor (TR1) and the transistor (TR2) whose gates respectively are connected to the gate lines connected to the selected terminals are turned on.

For example, when a selection scanning voltage of H level is outputted to the terminal G1-1 out of the terminals of the second group (G1), the transistors (TR1) which are connected to the scanning lines (GL) of first group are turned on. Further, when a selection scanning voltage of H level is outputted to the terminal G2-1 out of the terminals of the third group (G2), the transistors (TR2) which are connected to the scanning lines (GL) of the first group to the tenth group are turned on.

Next, when a selection scanning voltage of H level is outputted from the terminal which is selected from the terminals of the first group (G0), the first electrode is connected to the scanning line (GL) selected within the selected group i.e., the gate line connected to the terminal selected out of the terminals of the first group (G0). The first transistor (TR1) whose gate is connected to the gate line that is connected to the terminal selected out of the terminals of the second group (G1) and the second terminal of the first transistor (TR1) are connected to the first terminal. The selection scanning voltage is supplied to the scanning line (GL) connected to the second transistor (TR2) whose gate is connected to the gate line that is connected to the terminal selected out of the terminals of the third group (G3).

Thus, the thin film transistor (active element) (TFT) whose gate is connected to the scanning line (GL) selected in the selected group is turned on, and a video voltage (grayscale voltage) is written in the pixel electrode (PX) from the video signal (DL) via the thin film transistor (TFT).

Next, when a selection scanning voltage of H level is outputted from the terminal next selected out of the terminals of the first group (G0), the thin film transistor (active element) (TFT) whose gate is connected to the scanning line (GL) next selected in the selected group is turned on, and a video voltage is written in the pixel electrode (PX) from the video line (DL) via the thin film transistor (TFT).

By sequentially selecting the scanning lines (GL) in this manner, it is possible to display an image on the liquid crystal display panel.

As described above, the scanning lines (GL) are sequentially selected, and a video voltage outputted from the scanning circuit (RDV) is written in pixels on the selected scanning line (GL).

However, the gate lines (GL) other than the selected scanning line (GL) are in a floating state and hence, being influenced by a change of a video voltage supplied to the video line (DL), a voltage of the scanning line (GL) in a floating state rises, and a thin film transistor (TFT) whose gate is connected to the scanning line (GL) in a floating state is turned on so that there exists a possibility that a video voltage is written in a pixel other than the selected pixel.

To prevent such writing of the video voltage in other pixel, as shown in FIG. 6, within a predetermined period at the beginning of 1 horizontal period (period T1 shown in FIG. 4), a scanning voltage of H level is outputted to all the terminals of the second group (G1) and all the terminals of the third group (G2). Simultaneously, a voltage of Low level (hereinafter referred to as L level) is outputted to all the terminals of the first group (G0).

Accordingly, all the scanning lines (GL) are fixed to L level. Thereafter, a video voltage is outputted to the video lines (DL) from the scanning circuit (RDV). Even when a voltage on the video lines (DL) is changed, the scanning lines (GL) are fixed to the L level and hence, a voltage of the scanning lines (GL) does not rise.

Next, as indicated by a waveform of a voltage supplied to the terminal (G1-1) shown in FIG. 6, the terminals to be selected out of the terminals of the second group (G1) and the terminals to be selected out of the terminals of the third group (G2) are held at H level, and other terminals are held at L level. Then, after a period T2 which continuously follows the period T1 elapses, that is, after a voltage change on the video line (DL) is settled, a selection scanning voltage of H level is sequentially supplied to the terminals of the first group (G0) so that a video voltage is written in the selected pixels and an image is displayed.

In this embodiment, the explanation has been made with respect to a case where the scanning lines (GL) are driven with three-stage constitution. However, the scanning lines (GL) may be driven with four-stage constitution or more. Further, when the scanning lines (GL) are driven with N-stage constitution, assuming p as a number not less than of 2 and not more than N (2≦p≦N), it is preferable that the difference between k(p−1) and kp(2≦p≦N) is N or less.

Further, although the explanation has been made with respect to the case where the vertical scanning circuit is driven with the multi-stage constitution in the above-mentioned embodiment, the horizontal scanning circuit may be also driven with the multi-stage constitution.

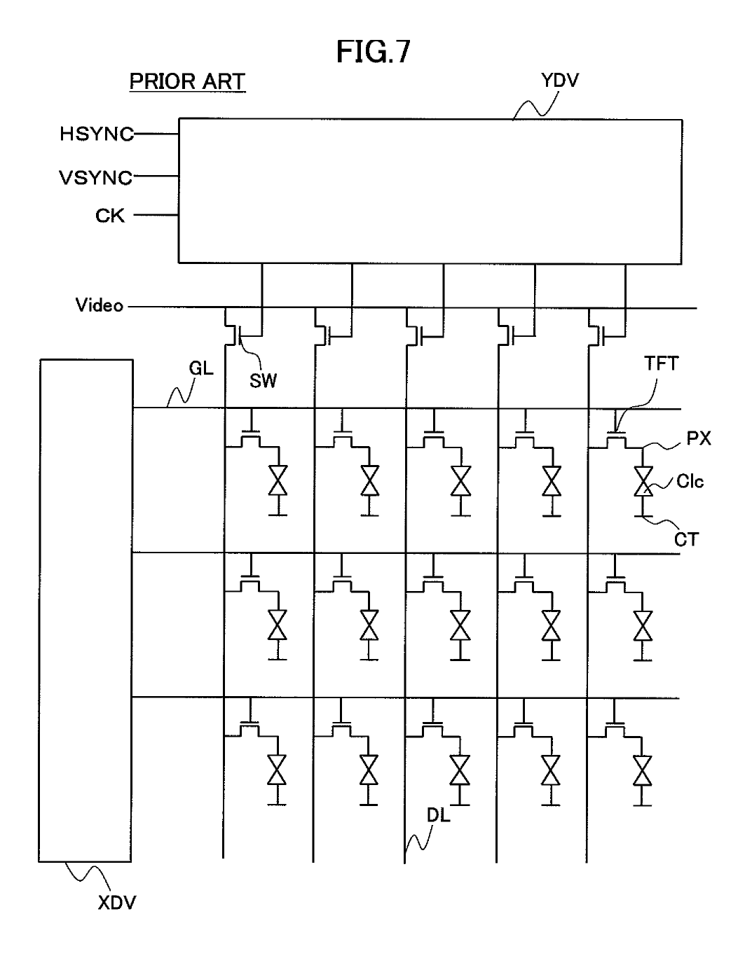

FIG. 7 is a diagram showing an equivalent circuit of another conventional TFT-method active-matrix-type liquid crystal display panel.

In a liquid crystal display panel shown in FIG. 7, video lines lines (DL) are connected to a video signal line (VIDEO) via switching elements (SW). By sequentially turning on these switching elements (SW) by a horizontal scanning circuit (YDV) in synchronism with a dot clock (CK), a video voltage on the video signal line (VIDEO) is supplied to the video lines (VIDEO).

The horizontal scanning circuit (YDV) shown in FIG. 7 may also have the circuit constitution of the multi-stage constitution explained in conjunction with the respective embodiments previously.

However, to allow the horizontal scanning circuit (YDV) shown in FIG. 7 to have the circuit constitution of the multi-stage constitution explained in conjunction with the respective embodiments previously, it is necessary to use a dot clock (CK) in place of the 1H period.

For example, when the horizontal scanning circuit (YDV) shown in FIG. 7 adopts the circuit constitution of the two-stage constitution shown in FIG. 3, the horizontal scanning circuit (YDV) sequentially outputs a selection scanning voltage of H level to terminals G0-1 to G0-30 out of the terminals of the first group (G0) for every 1 dot clock (CK).

Further, the horizontal scanning circuit (YDV) sequentially outputs a selection scanning voltage of H level to terminals G1-1 to G1-29 out of the terminal of the second group (G1) for every 30 dot clocks (CK). However, a video voltage is always supplied to the video lines (DL) from the horizontal scanning circuit (YDV) within 1 frame period so that there is no possibility that the video lines (DL) assume a floating state and hence, it is unnecessary to adopt a driving method used in the above-mentioned embodiments.

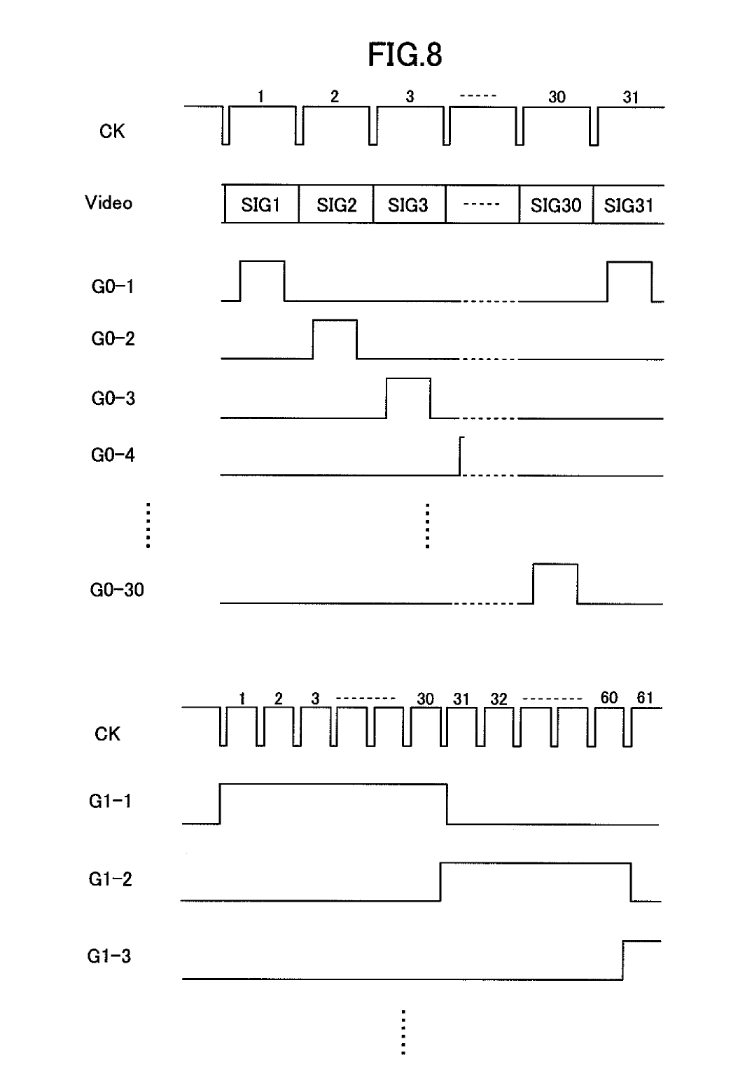

That is, it is unnecessary to adopt the driving method shown in FIG. 4 where a scanning voltage of H level is outputted to all the terminals of the second group (G1) within a predetermined period before outputting a video voltage from the scanning circuit (RDV) (period corresponding to T1 in FIG. 4) and, simultaneously, a voltage of Low level (hereinafter referred to as L level) is outputted to all the terminals of the first group (G0). For example, FIG. 8 is a timing chart of a case where the horizontal scanning circuit (YDV) shown in FIG. 7 adopts the circuit constitution of two-stage constitution shown in FIG. 3.

In the above-mentioned respective embodiments, the scanning circuit (RDV), the vertical scanning circuit (XDV) or the horizontal scanning circuit (YDV) is constituted of a circuit incorporated in a semiconductor chip, and the semiconductor chip is mounted on one substrate out of the pair of substrates which constitutes the liquid crystal display panel. However, the scanning circuit (RDV), the vertical scanning circuit (XDV) or the horizontal scanning circuit (YDV) may be constituted of a poly-Si thin film transistor, and the circuit may be provided to a liquid-crystal-side surface of one substrate out of the pair of substrates which constitutes the liquid crystal display panel.

In the above-mentioned respective embodiments, the explanation has been made with respect to the case where the present invention is applied to the liquid crystal display device. However, the present invention is not limited to the liquid crystal display device, and is also applicable to a display device which uses organic light emitting diode elements or surface conductive electron emission elements as a display panel.

Although the inventions made by inventors of the present invention have been explained specifically in conjunction with the embodiments, it is needless to say that the present invention is not limited to the embodiments, and various modifications are conceivable without departing from the gist of the present invention.

What is claimed is:

1. A display device comprising:
a plurality of pixels;
a plurality of scanning lines configured to input a scanning voltage to the plurality of pixels; and
a scanning line drive circuit configured to supply the scanning voltage to the plurality of scanning lines,
wherein the scanning lines are divided into kN× . . . ×k2 groups assuming N as an integer of 2 or more, wherein the number of the scanning lines in each of the groups is k1 at maximum,
wherein n as an integer not less than 1 and not more than N, j as an integer not less than 1 and not more than N−1, and m as an integer not less than 2 and not more than N−1 or less,
wherein the display device further comprises:
a first gate line group to an Nth gate line group of gate lines, wherein each of the first gate line group to the Nth gate line group of the gate lines include kn (1≦n≦N) gate lines respectively; and
series circuits having (N−1) transistors ranging from a first transistor to a (N−1)th transistor,
wherein each of the (N−1) transistors is provided for each of the scanning lines,
wherein one end of each of the scanning lines is connected to a second electrode of the (N−1)th transistor,
wherein a first electrode of the first transistor is connected to any one of the gate lines of the first gate line group,
wherein a control electrode of the j (1≦j≦N−1)th transistor is connected to any one of the gate lines of the (j+1)th gate line group,
wherein the scanning line drive circuit outputs a first selection scanning voltage for selecting the scanning lines within each of the groups for every 1 horizontal scanning period to the gate lines of the first gate line group including k1 gate lines,
wherein the scanning line drive circuit outputs a second selection scanning voltage for selecting the scanning lines in one second group out of second groups where the group including k1 scanning lines is set as 1 unit for every k1 horizontal scanning periods to the gate lines of the second gate line group including k2 gate lines, and
wherein the scanning line drive circuit outputs the (m+1)th selection scanning voltage for selecting the scanning lines in one (m+1)th group out of (m+1)th groups where a mth group including km scanning lines is set as 1 unit for every (km× . . . ×k1) horizontal scanning periods to the gate lines of the (m+1)th gate line group having k(m+1) (2≦m≦N−1) gate lines.

2. The display device according to claim 1, wherein assuming p as an integer not less than 2 and not more than N, a difference between k(p−1) and kp(2≦p≦N) is set to N or less.

3. The display device according to claim 1, wherein the selection scanning voltage is outputted to all the gate lines of the second gate line group to the Nth gate line group from the scanning line drive circuit, and
wherein a non-selection scanning voltage is outputted to all the gate lines of the first gate line group within a period T1 at the beginning of said each horizontal scanning period.

4. The display device according to claim 3, wherein the scanning line drive circuit, after a lapse of the period T1, outputs a non-selection scanning voltage to the gate lines other than the gate lines to which the second to the Nth selection scanning voltages are outputted out of the gate lines of the second gate line group to the Nth gate line group, and
wherein the scanning line drive circuit, after a lapse of a period T2 which continuously follows the period T1, outputs the first selection scanning voltage to the gate lines selected out of the gate lines of the first gate line group.

5. The display device according to claim 1, wherein a video line drive circuit and the scanning line drive circuit are formed of the same semiconductor chip.

6. The display device according to claim 1, wherein each of the plurality of pixeles includes a thin film transistor which is an active element, and
wherein a semiconductor layer of the thin film transistor is formed of an amorphous silicon layer.

7. The display device according to claim 6, wherein the semiconductor layer of the (N−1) transistors ranging from the first transistor to the (N−1)th transistor is formed of an amorphous silicon layer.

8. The display device according to claim 1, wherein each of the plurality of the pixeles includes a thin film transistor which is an active element, and
wherein a semiconductor layer of the thin film transistor is formed of a micro-crystalline silicon layer.

9. The display device according to claim 8, wherein the semiconductor layer of the (N−1) transistors ranging from the first transistor to the (N−1)th transistor is formed of a micro-crystalline silicon layer.
